(19) United States
(12) Patent Application Publication
(10) Pub. No.: US 2011/0222958 A1
(43) Pub. Date: Sep. 15, 2011

(54) SELF-LOCKING SLIDE BAR

(75) Inventor: Renzhong Li, Xiamen (CN)

(73) Assignee: XIAMEN SOLEX HIGH-tECH INDUSTRIES CO., LTD, Fujian (CN)

(21) Appl. No.: 13/125,147

(22) PCT Filed: Jun. 30, 2009
(86) PCT No.: PCT/CN09/72540

§ 371 Date: Apr. 20, 2011

(30) Foreign Application Priority Data
Nov. 26, 2008 (CN) 200810072256.8

(51) Int. Cl. F16B 7/04

(52) U.S. Cl. 403/83

(57) ABSTRACT

A self-locking slide bar has a rod body and a shower head fixing seat sleeving the rod body. A sleeve seat for fixing a shower handle is outside the fixing seat. The fixing seat has a sliding upper and lower seat cover, and a floating block. The floating block sleeves the rod body, and a friction plate is provided on the inner wall of the floating block. An orifice is located on the contrary position to the friction plate and contacts the rod body. The floating block is movably positioned in a containing cavity made up of the upper and lower cover of the sliding seat. In the normal state, the lower end of the floating block contacts the sliding seat lower cover, the orifice and the friction plate act on two sides of the rod body, and the shower head fixing seat is fixed on the rod body.

### FIELD OF THE INVENTION

The present invention relates to a sanitary product, especially relates to a slide bar for adjusting or fixing the position of the shower.

### BACKGROUND OF THE INVENTION

Generally, there are two manners of installing shower head: in the first manner, the position of the shower head is fixed, and the shower head is connected to the concealed port embedded in the walls of the hotel or the standard apartment; in the second manner, the shower head is movable and widely applied in the domestic life, said shower head communicates with water by a flexible pipe connected to the water supply, the user can hold the shower or put the shower in the fixing seat of the wall.

In order that the position of the shower head is flexible, the slide bar is generally installed in the bathroom, further a fixing seat is movably disposed on said slide bar, so the height of the shower head can be adjusted and it is convenient for both the adult and the children to use.

However, the position adjustment of the fixing seat of the traditional technique is realized by a fastening member on the fixing seat, when it needs to adjust to the height of the shower head, firstly the user releases the fastening member, then lifts the fixing seat along the slide bar until it reaches the required position, finally fastens the fixing seat on the required position, therefore the height adjustment of said slide bar needs both hands of the user to operate, if there are foams in the hands of the user, the position of the fixing seat can not be quickly adjusted.

### SUMMARY OF THE INVENTION

The objective of the present invention is to provide a self-locking slide bar, by applying such slide bar, the user doesn't need to use both hands to adjust the position of the fixing seat, and the fixing seat of the present slide bar can be automatically fixed.

In order to realize the above objective, the solution of the present invention is: a self-locking slide bar consists of a rod body and a shower head fixing seat sleeving the rod body, a sleeve seat for fixing a shower handle is provided outside the shower head fixing seat; wherein said shower head fixing seat comprises a sliding seat upper cover, a sliding seat lower cover, and a floating block; said floating block sleeves the rod body, an eccentric orifice sleeves said rod body is provided on the floating block; said floating block is movably provided in a containing cavity made up of the upper cover and the lower cover of the sliding seat.

A friction plate is provided in said eccentric orifice.

The inner wall of said eccentric orifice is a friction sleeve.

Said sliding seat upper cover is a protecting cover, said protecting cover has an eccentrical through hole adapting the section of said rod body, a mating hole is formed on the lower portion of the side wall inside said protecting cover.

The sliding seat lower cover is a casing, the inside of which has a stepped fixture block extending into the mating hole of the sliding seat upper cover and movably cooperating with the sliding seat upper cover, a through hole which adapts the section of said rod body is further disposed on the sliding seat lower cover and opposite to the eccentrical through hole of the sliding seat upper cover, a sleeve seat upward extends from the peripheral of said through hole of the sliding seat lower cover.

A spring is further disposed between the outside of the floating block and the sliding seat upper cover.

A sinking tank for accommodating said spring is axially disposed outside the floating block.

The upper portion of said sinking tank is trumpet-shaped.

Since the fixing seat of the present slide bar has a floating block equipped with an eccentric orifice, so when the floating block inclines relative to the rod body, a friction force generated by the eccentric orifice will act on the rod body, so the fixing seat will be automatically fixed on the slide bar by the friction force, and the height of the fixing seat will be conveniently adjusted, it is more convenient and time-saving compared to the traditional structure of the fixing seat wherein the user has to use both two hands.

### BRIEF DESCRIPTION OF THE DRAWINGS

FIG. 1 illustrates the fixing seat after it slides upward along the slide bar and the static state of the fixing seat;

FIG. 2 illustrates the fixing seat after it slides downward along the slide bar.

### DETAILED DESCRIPTION OF THE EMBODIMENTS

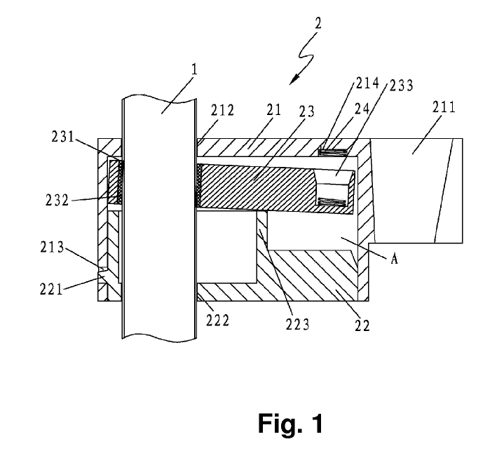

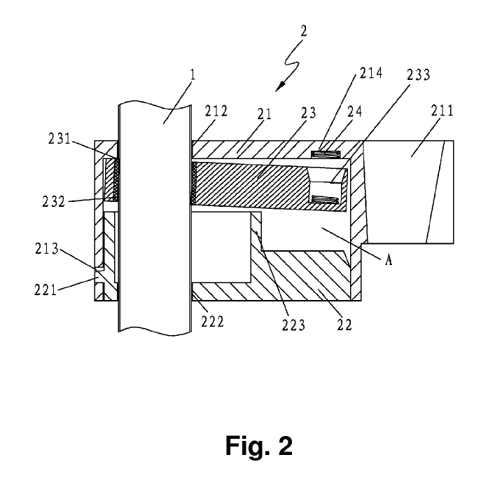

The self-locking slide bar of the present invention according to FIG. 1 and FIG. 2, it comprises a rod body 1 and a fixing seat 2 sleeves on said rod body 1.

The rod body 1 is a long, slender pipe, the upper and lower portions of the rod body are fixed on the wall, said rod body 1 can be made of metal.

The fixing seat 2 comprises a sliding seat upper cover 21, a sliding seat lower cover 22, a floating block 23 and a spring 24;

the sliding seat upper cover 21 is a protecting cover, an inverted cone sleeve seat 211 is extended from the outside of the sliding seat upper cover 21 for holding the shower handle; the casing has an eccentrical through hole 212 adapting with the section of the rod body 1, a adapting hole 213 is formed on the lower portion of the inner wall of the protecting cover;

the sliding seat lower cover 22 is a casing relative to the protecting cover, the inside forms a stepped fixture block 221 which is movably matched with the sliding seat upper cover 21 by stretching into said adapting hole 213, meanwhile a containing cavity A is formed between the lower cover 22 and the upper cover 21, further a through hole 222 adapts with the section of the rod body 1 is formed on the lower cover 22 corresponds to said through hole 212, and a sleeve seat 223 is upward extended from the periphery of said through hole 22.

Said floating block 23 is an eccentrical sleeve, the inner wall of its eccentric orifice 231 has a friction plate, so the interior diameter of the eccentric orifice 231 is clearance fit with the external diameter of the rod body 1; alternatively, a friction sleeve 232 is disposed on the inner wall of said eccentric orifice 231, the interior diameter of the friction sleeve 232 is clearance fit with the external diameter of the rod body 1; a sinking tank 233 is axially formed outside of the floating block 23 for accommodating the spring 24.

Please refer to the accompanying drawings, when the self-locking slide bar is assembled, the spring 24 is put on the sinking tank 233 of the floating block 23 and then put in the sliding seat upper cover 21 from bottom to top, then the fixture block 221 of the sliding seat lower cover 22 is extended into the adapting hole 213 of the upper cover 21, so the fixing seat 2 is formed by the cooperation of the upper cover 21 and the lower cover 22, the floating block 23 is movably disposed in the containing cavity A formed by the upper cover 21 and the lower cover 22, the upper end of the side wall of the sleeve seat 223 of the lower cover 22 upward resists the approximate middle portion of the outside of the floating block 23, meanwhile the upper portion of the spring 24 upward depends in a fixing groove 214 of the upper cover 21, and the lower portion of the spring 24 upward depends on the lower portion of the sinking tank 233 of the floating block 23, finally sleeves the fixing seat 2 on the rod body 1. A pivot is formed on the upper end of the side wall of the sleeve seat 223, the end of the floating block 23 approaching the spring 24 is heavier than the end of the floating block 23 approaching the rod body 1. The upper portion of the sinking tank 233 is trumpet-shaped, such that it is convenient for the spring 24 to expand and contract.

As showed in FIG. 1, in the normal state, because said floating block 23 is eccentrically disposed and due to the reset force of the spring 24, the floating block 23 will downward incline relative to the rod body 1, and the outside of the floating block 23 will contact with the sleeve seat 223 of the lower cover 22, that is the floating block 23 will deflect clockwisely, so the friction sleeve 232 will exert a relative strong positive pressure to the upper portion of the left side of the rod body 1 and the lower portion of the right side of the rod body 1, so the whole fixing seat 2 will be fixed on the slide bar 1 and will not slide downward due to the friction force generated by the friction sleeve.

When the user needs to upward lift the fixing seat 2, that is the fixing seat 2 is needed to slide upward relative to the rod body 1, firstly lifts upward the whole fixing seat 2, then the upper end of the sleeve seat 223 of the lower cover 22 contacts with the approximate middle portion of the lower portion of the floating block 23, so the floating block 23 will rotate anti-clockwisely relative to the rod body (tends to be horizontal), at this time the positive pressure generated by the friction sleeve 232 in the eccentric orifice of the floating block 23 reduces rapidly, and the friction force reduces rapidly, too, so the whole fixing seat 2 will fluently slide upward, when the fixing seat 2 reaches the required height, releases the fixing seat 2, then the floating block 23 will clockwisely rotate downward and sideways due to the reset force of the spring 23 and the eccentrical gravity, and the friction sleeve 232 will generate a relative strong positive pressure to the upper portion of the left side of the rod body 1 and the lower portion of the right side of the rod body 1, so the whole fixing seat will be fixed on the rod body 1 and could not slide due to the friction force, therefore the position of the fixing seat is fixed.

As showed in FIG. 2, when the user needs to reduce the height of the fixing seat 2, that is the fixing seat 2 needs to slide downward relative to the rod body 1, the floating block 23 will not move due to the friction force exerted on the rod body 1 by the friction sleeve 232, while the upper cover 21 can only compress the spring 24 and the spring 24 will move downward; when the upper cover 21 contacts the upper end of the inside of the floating block 23, the floating block will rotate anti-clockwisely relative to the rod body 1 (tends to be horizontal), at this time the positive pressure of the friction sleeve 232 will gradually reduce, and the friction force will reduce correspondingly, so the fixing seat 2 will slide downward under certain force value, then releases the fixing seat 2 after it slides to the required position, so the floating block 23 will clockwisely rotate downward and sideways relative to the rod body 1, the friction sleeve 232 will generate a relative strong positive pressure to the upper portion of the left side of the rod body 1 and the lower portion of the right side of the rod body 1, thus the whole fixing seat 2 will be fixed on the rod body 1 and could not slide due to the friction force, therefore the location of the fixing seat 2 is fixed.

Concluded from the above description, by disposing the eccentrical floating block 23 inside the fixing seat 2 and the friction sleeve 232, when the floating block 23 inclines relative to the rod body 1, the friction sleeve 232 will exert a friction force on the rod body 1, so the fixing seat 2 will be automatically fixed on the slide bar 1, so the height adjustment of the fixing seat 2 will be time-saving, the operation of the present invention is more convenient and time-saving compared to the traditional technique wherein the user has to use both two hands for adjustment.

### INDUSTRIAL APPLICABILITY

The self-locking slide bar of the present invention, wherein the height adjustment of the fixing seat on the slide bar body is time-saving, the operation of the present invention is more convenient and time-saving compared to the traditional technique wherein the user has to use both two hands for adjustment.

1. A self-locking slide bar consists of a rod body and a shower head fixing seat sleeving the rod body, a sleeve seat for fixing a shower handle is provided outside the shower head fixing seat; wherein said shower head fixing seat comprises a sliding seat upper cover, a sliding seat lower cover, and a floating block said floating block sleeves the rod body, an eccentric orifice sleeves said rod body is provided on the floating block; said floating block is movably provided in a containing cavity made up of the upper cover and the lower cover of the sliding seat.

2. The self-locking slide bar according to claim 1, wherein a friction plate is provided in said eccentric orifice.

3. The self-locking slide bar according to claim 1, wherein the inner wall of said eccentric orifice is a friction sleeve.

4. The self-locking slide bar according to claim 1, wherein said sliding seat upper cover is a protecting cover, said protecting cover has an eccentrical through hole adapting the section of said rod body, a mating hole is formed on the lower portion of the side wall inside said protecting cover.

5. The self-locking slide bar according to claim 1, wherein the sliding seat lower cover is a casing, the inside of which has a stepped fixture block extending into the mating hole of the sliding seat upper cover and movably cooperating with the sliding seat upper cover, a through hole which adapts the section of said rod body is further disposed on the sliding seat lower cover and opposite to the eccentrical through hole of the sliding seat upper cover, a sleeve seat upward extends from the peripheral of said through hole of the sliding seat lower cover.

6. The self-locking slide bar according to claim 1, wherein a spring is further disposed between the outside of the floating block and the sliding seat upper cover.

7. The self-locking slide bar according to claim 6, wherein a sinking tank for accommodating said spring is axially disposed outside the floating block.

8. The self-locking slide bar according to claim 1, wherein a sinking tank for accommodating said spring is disposed on said floating block and far away from the end of said eccentric orifice; a through hole is disposed on the sliding seat lower cover for adapting the section of the rod body, an eccentrical sleeve seat upward extends from the peripheral of said through hole; a pivot for upward resisting said floating block is formed on the upper end of a side wall of the sleeve seat.

9. The self-locking slide bar according to claim 8, wherein the upper end of a side wall of the sliding seat upward resist the approximate middle portion of the floating block, the end of the floating block approaching the spring is heavier than the end of the floating block approaching the rod body, when it is in the normal state, the spring inclines downward.

10. The self-locking slide bar according to claim 7, wherein said sinking tank is trumpet-shaped, meanwhile a locating groove for fixing the spring is disposed on the corresponding position of the sliding seat upper cover.

11. The self-locking slide bar according to claim 4, wherein the sliding seat lower cover is a casing, the inside of which has a stepped fixture block extending into the mating hole of the sliding seat upper cover and movably cooperating with the sliding seat upper cover, a through hole which adapts the section of said rod body is further disposed on the sliding seat lower cover and opposite to the eccentrical through hole of the sliding seat upper cover, a sleeve seat upward extends from the peripheral of said through hole of the sliding seat lower cover.
